(19) United States
(12) Patent Application Publication
(10) Pub. No.: US 2004/0012291 A1
(43) Pub. Date: Jan. 22, 2004

(54) High density winding for electric motor

(76) Inventor: Paul S. McLennan, London (CA)

Correspondence Address: Elsa Keller, Legal Assistant, Intellectual Property Department, SIEMENS CORPORATION, 186 Wood Avenue South, Iselin, NJ, 08830, US

(21) Appl. No.: 10/199,806

(22) Filed: Jul. 19, 2002

(51) Int. Cl. H02K 3/00

(52) U.S. Cl. 310/180

(57) ABSTRACT

An armature core for an electric motor includes a core element and primary and secondary generally cylindrical wirings or conductors wound about the core element. The primary conductor has a diameter which is greater than the secondary conductor. The secondary conductor is wound around the core element and positioned within spaces or voids or passageways defined between at least three adjacent portions or turns of the primary conductor. The diameter of the secondary conductor may be selected such that the secondary conductor substantially fills the voids between the adjacent contacting portions or turns of the primary conductor. The primary and secondary conductors may be simultaneously wound onto the core element.

### FIELD OF THE INVENTION

The present invention relates generally to electric motors and, more particularly, to an electric motor having a high density winding.

### BACKGROUND OF THE INVENTION

The performance of an electric motor, such as a multipole direct current electric motor, is controlled by several physical characteristics or constraints. One factor limiting motor performance is the configuration of the winding of the conductor element about the core of the motor. More particularly, the motor performance is limited or affected by the percentage of wire fill in the armature core slots. Because the stall torque of the motor is generally proportional to the current through the motor, decreasing the winding resistance may result in an increase in the stall torque for a given speed of the motor. The increase in stall torque may improve the motor operating efficiency.

Generally, manufacturing and packaging limitations limit or prevent some forms of a higher winding density or lower winding resistance from being implemented. For example, a lower winding resistance may be achieved with a larger diameter, continuous strand of magnet wire or conductor. While such a winding may provide a lower armature resistance, this approach may cause problems with the wire termination and the wire pile height of the wiring of the armature core.

In some applications, a compound winding process may provide two or more sets of windings onto the armature core in subsequent winding operations. For example, a first strand of wiring may be wound multiple times around an armature core and then a second strand of wiring may be wound multiple times around the core on top of or around the first strand of wiring. While this may reduce the difficulties in winding and terminating a single lower gauge wire, and may provide an increase in the percentage of wire fill in the armature core slot, the second strand of wiring requires an additional winding operation and, thus, increases the machine time or manufacture time and cost of the motor.

It has also been proposed to implement conductors having non-uniform and non-cylindrical cross-sections to provide an increased density of the wiring around the core. However, this may be a costly approach and may be difficult to manufacture, since different machines or tools may be required which are adapted to handle the non-cylindrical and different cross-sectional wires around the core.

### SUMMARY OF THE INVENTION

The present invention is intended to provide a high density winding for an electric motor and a process for winding conductors for electric motors in a high density manner, which provides an increased percentage of armature slot fill for the electric motor. The high density winding of the present invention includes a primary wire or conductor and a secondary wire or conductor which at least partially, and preferably substantially, fills the voids between the portions or turns of the primary conductor.

According to an aspect of the present invention, a core for an electric motor includes a core element, a first conductor or wiring having a first diameter, and a second conductor or wiring having a second diameter. The first diameter is greater than the second diameter. The first conductor is wound around the core element a plurality of times to define a plurality of windings or portions or turns of the first conductor, while the second conductor is wound around the core element a plurality of times to define a plurality of windings or portions or turns of the second conductor. At least some of the plurality of portions of the second conductor may be positioned within respective voids, wherein each of the respective voids is defined by at least three adjacent portions of the plurality of portions of the first conductor.

Preferably, the first and second conductors are generally cylindrical, continuous conductors. Preferably, the plurality of portions of the first conductor generally define first and third layers of the windings or portions, while the plurality of portions of the second conductor generally define a second layer of windings or portions which is positioned generally between the first and third layers of windings. Preferably the first and third layers of windings contact one another at corresponding surfaces of the windings, whereby the void is defined between the contacting corresponding surfaces of the first and third layers.

According to another aspect of the present invention, a method of forming an armature core for an electric motor includes providing a core element, winding a first conductor or wiring around the core element a plurality of times and winding a second conductor or wiring around the core element a plurality of times. The first generally cylindrical conductor has a first diameter which is greater than a second diameter of the second generally cylindrical conductor. The method includes at least partially filling voids defined between adjacent sections or portions of the first generally cylindrical conductor with the second generally cylindrical conductor.

Preferably, the first and second conductors are generally cylindrical, continuous conductors. In one form, the portions of the first conductor define first and third layers of the first conductor, while the portions of the second conductor define a second layer of the second conductor positioned generally between the first and third layers. The first and third layers are preferably formed from a continuous or unitary segment of the first conductor. The winding of the first conductor and the winding of the second conductor are preferably performed generally simultaneously with one another.

According to another aspect of the present invention, an electric motor includes a core, which includes a core element, a primary generally cylindrical conductor and a secondary generally cylindrical conductor. The primary conductor has a first diameter and the secondary conductor has a second diameter. The first diameter is greater than the second diameter. The primary conductor is wound around the core element a plurality of times to define a plurality of portions or turns of the primary conductor, while the secondary conductor is wound around the core element a plurality of times to define a plurality of portions or turns of the secondary conductor. At least some of the plurality of portions of the secondary conductor are positioned within respective voids defined by at least three adjacent portions of the plurality of portions of the primary conductor.

Therefore, the present invention provides a high density winding for an armature core. The high density winding includes different sized, generally cylindrical conductors or wirings. The different sized conductors provide for a higher density winding around the core of the electric motor. The motor stall torque thus may be improved without substantially affecting other design parameters, such as wire pile height or the like. Preferably, the winding of the two wires or conductors onto the armature core may be performed generally simultaneously, which provides a lower machine cycle time for manufacturing the core element than the cycle time for a two step process.

These and other objects, advantages, purposes and features of the present invention will become apparent upon review of the following specification in conjunction with the drawings.

### BRIEF DESCRIPTION OF THE DRAWINGS

FIG. 1 is an exploded perspective view of a multipole DC motor in accordance with the present invention;

FIG. 2 is a side elevation and partial sectional view of the motor of FIG. 1;

FIG. 3 is an end elevation of the armature core of the motor of FIGS. 1 and 2, with a pair of conductors partially wound around and through the slots of the armature core;

FIG. 4 is a sectional view of a portion of a slot of an armature core element, having portions or turns of a secondary conductor positioned within voids defined by four adjacent portions or turns of a primary conductor in accordance with the present invention;

FIG. 5 is a sectional view of a portion of a slot of an armature core element, having portions or turns of a secondary conductor positioned within voids defined by three adjacent portions or turns of a primary conductor in accordance with the present invention; and

FIG. 6 is a graphical representation of the speed versus the torque of a motor having different winding densities.

### DESCRIPTION OF THE PREFERRED EMBODIMENTS

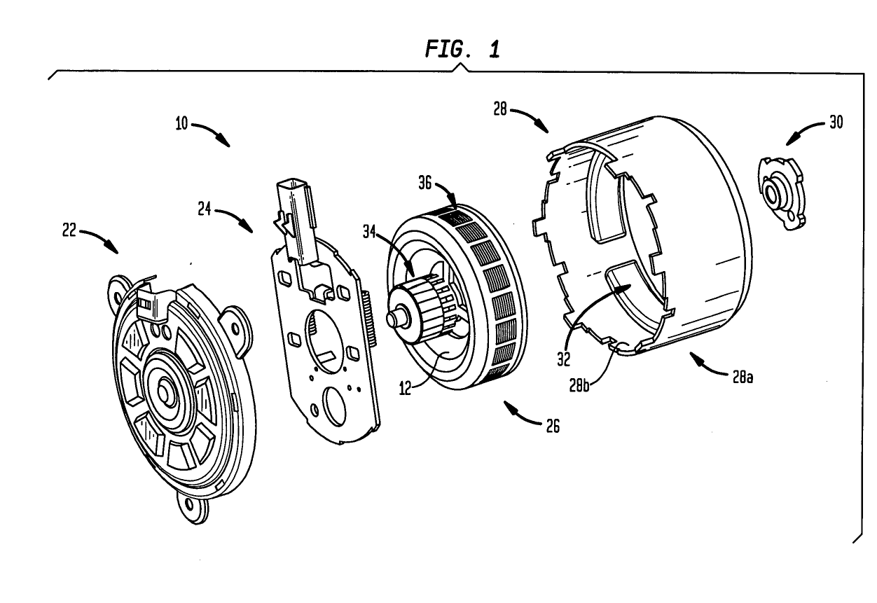

Referring now specifically to the drawings and the illustrative embodiments depicted therein, an electric motor 10 includes an armature 26 having an armature core element 12 defined by laminations 36, which define a plurality of slots 12a, and conductive wires or wiring 14 wound about the slots (FIGS. 1-4). Laminations 36 may be any form and may be suitable for the type of electric motor of the particular application. In the illustrated embodiment, armature 26 includes a commutator 34 on core element 12, as is known in the art. Electric motor 10 includes a stator 28 defined by an end cap 22, armature 26, a stator housing 28a, a drive plate 30, and one or more magnets 32 positioned around an interior surface 28b of housing 28a. The housing 28a and end cap 22 substantially encase the armature and a brushcard 24, as is also known in the art.

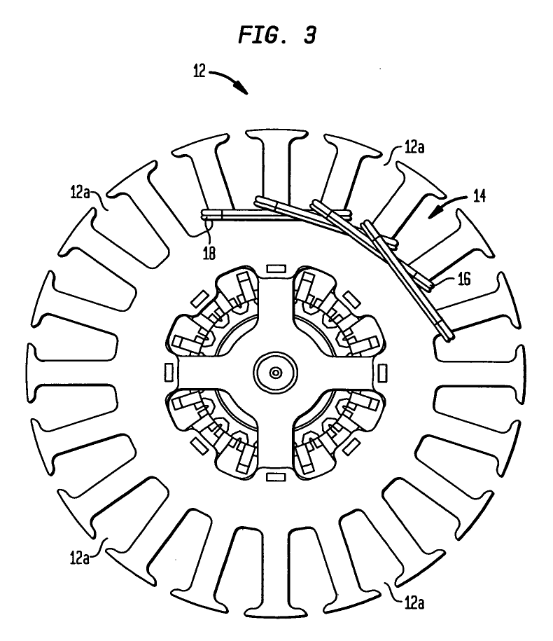

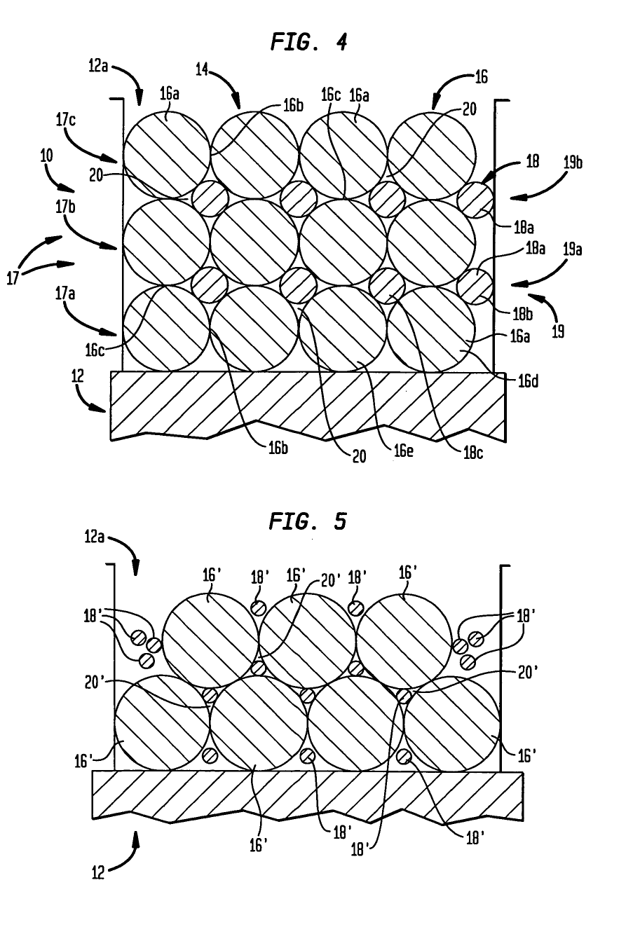

As shown in FIGS. 3 and 4, conductive wiring 14 includes a primary wiring 16 and a secondary wiring 18. Both the primary wiring 16 and the secondary wiring 18 are generally cylindrical conductive wirings or conductors, such as conventional copper wiring or the like. The primary wiring 16 has a diameter which is greater than a diameter of the secondary wiring 18, as can be seen in FIG. 4. The primary and secondary wiring 16, 18 are wrapped or wound in and around the slots 12a of core element 12 multiple times or turns to provide a high density wiring around the core element 12.

Electric motor 10 may comprise any type of electric motor, such as, for example, a multipole direct current motor or the like. However, the core element and conductors of the present invention may be applicable to other types of motors, such as HVAC motors, ABS motors, engine cooling fan motors, power window motors and brushless DC motors and the like, without affecting the scope of the present invention.

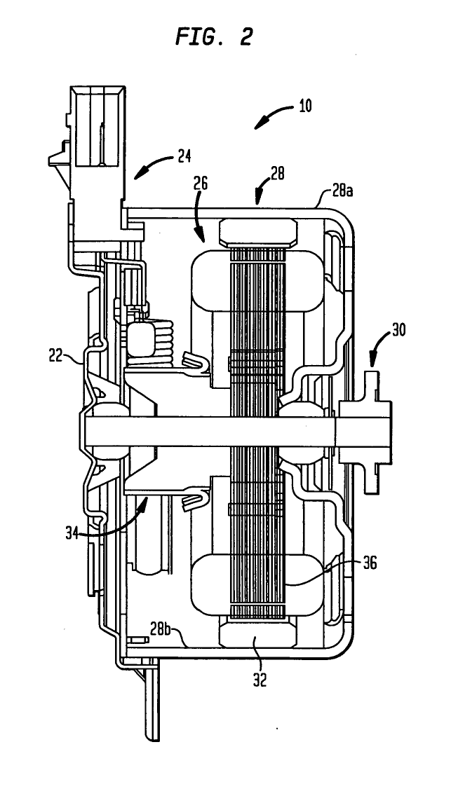

The conductor wirings 16, 18 (not shown in FIGS. 1 and 2 for purposes of clarity) are wrapped or wound around the slots 12a of core element 12 multiple times or turns, with each circumferential winding or turn of the conductor defining a conductor winding or portion or section 16a, 18a of the wirings 16, 18, respectively. As shown in FIG. 3, the primary and secondary conductors 16, 18 may be continuous strands wrapped or wound through all of the slots 12a of core element 12 (shown as only two single strands of conductors at some of the slots in FIG. 3 for purposes of clarity). However, it is envisioned that the conductors of the present invention may be non-continuous strands or segments placed into the slots, such as for AC machines which commonly use preformed coils or wire segments placed individually into the slots, without affecting the scope of the present invention.

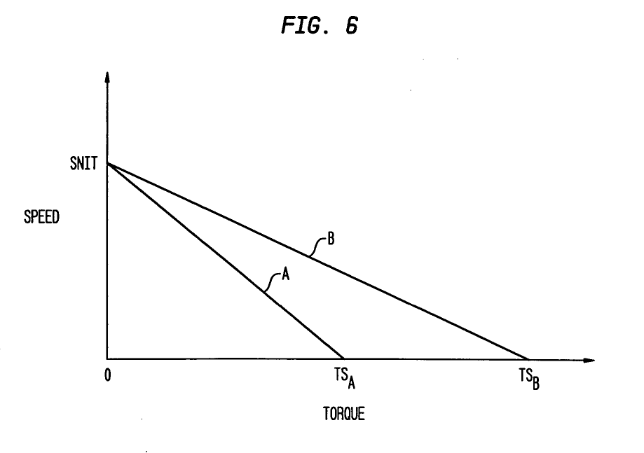

As shown in FIG. 4, primary wiring or conductor 16 may be wrapped or wound or positioned about the core element 12, such that the adjacent portions 16a of the wiring 16 contact one another at contact surfaces 16b and form one of a plurality of layers 17 of primary wiring 16. For example, primary wiring 16 may be wrapped around the core element 12 to form a first layer 17a. Additional layers 17b, 17c of primary wiring 16 may be provided via additional winding or turning of the primary wiring or conductor 16 about the core element 12. Additional layers may be wound depending on the size and/or shape of the slots and/or of the core element for the particular electric motor being manufactured. The layers 17 are wound about core element 12 a desired number of times with a continuous strand or segment of primary wiring 16. In the illustrated embodiment, the adjacent layers 17a, 17b and 17b, 17c of primary wiring 16 contact one another at corresponding contact surfaces 16c of the portions 16a, such that voids or cavities or passageways 20 are defined between the adjacent and contacting layers and between the adjacent and contacting conductor portions 16a (between the conductor portions 16a and their contact surfaces 16b, 16c). In the illustrated embodiment of FIG. 4, the voids 20 are defined by and within four adjacent and contacting portions of the primary wiring. However, as shown in FIG. 5, a secondary conductor 18′ may be wound or turned around slots 12a of core element 12 and positioned within voids 20′, which may be defined between three adjacent and contacting portions of a primary conductor 16′, without affecting the scope of the present invention.

It is further envisioned that other arrangements of the portions of the primary conductor may be provided which forms voids therebetween to receive at least one turn or portion of a secondary conductor, without affecting the scope of the present invention. As shown in FIG. 5, multiple portions or turns of the secondary conductor may be positioned in areas where there is additional space (such as along the side walls of the slot). Although not shown in FIG. 5, it is further envisioned that multiple turns or portions of the secondary conductor may be positioned within voids between adjacent and contacting portions or turns of the primary conductor, without affecting the scope of the present invention.

Secondary wiring or conductor 18 is wound about the core element in such a manner so as to substantially fill the voids 20 between the adjacent portions of the primary wiring 16. Accordingly, secondary wiring 18 is wound about the core element 12 to form layers 19, such as a layer 19a of secondary wiring 18 positioned generally between adjacent layers 17a, 17b of primary wiring 16. Additional layers 19 of secondary wiring 18 may be formed between adjacent layers 17 of primary wiring 16, such as layer 19b between layers 17b and 17c in FIG. 4. The layers 19a, 19b are formed by winding a continuous strand or segment of the secondary wiring 18 around the core element 12 a desired number of times. The number of layers 19 formed around the core element may be more or less than shown in the illustrated embodiment, depending on the size and/or shape of the slots and/or of the core element being wound, without affecting the scope of the present invention. However, although shown as generally even and uniform layers of conductors, the windings or turns of each conductor may not be so uniformly positioned about the core element, whereby some of the portions or turns of the secondary conductor may not be positioned between a void defined between three or four adjacent and contacting portions or turns of a primary conductor, without affecting the scope of the present invention.

Preferably, the winding of secondary wiring 18 is performed generally simultaneously with the winding of the primary wiring 16, such that machine cycle times are reduced or minimized, while providing the high density wiring configuration of the present invention. Each portion or section of the secondary wiring may thus be wound at least partially over the simultaneously wound portion or section of the primary wiring. For example, a portion 18b of secondary wiring 18 may be wound at the same time as a corresponding portion 16d of primary wiring during one wrap or rotation of a winding mechanism (not shown), and a portion 18c may be wound at the same time as another portion 16e during a next wrap or rotation of the winding mechanism, and so on. The winding mechanism may simultaneously guide and wrap the primary and secondary wirings together around the slots of the armature core until the desired number of rotations or windings is achieved. However, it is also envisioned that two or more windings or turns of the secondary conductor may be performed for each winding or turn of the primary conductor, so as to position or receive two or more portions or turns of the secondary conductor within at least some of the voids defined between the portions or turns of the primary conductor, without affecting the scope of the present invention. Such an arrangement would preferably provide a primary conductor size which would allow more turns or portions of the secondary conductor to fit into the void created or defined between adjacent primary conductor portions.

Preferably, the size of both conductors or wirings is selected such that the secondary wiring substantially fills the voids defined between respective three or four adjacent and contacting portions of the primary wiring, and preferably such that the portions of the secondary wirings contact each of the three or four adjacent and contacting portions of the primary wiring. The optimum diameter of the secondary wiring is preferably defined by the size of the voids formed by the contacting primary wiring portions. In the illustrated embodiment of FIG. 4, the primary wiring 16 is an 18.5 gage wire, while secondary wiring 18 is a 26 gage wire, such that the portions of secondary wiring 18 substantially fill the voids 20 between the respective four adjacent portions of primary wiring 16. However, other sized wires may be implemented, without affecting the scope of the present invention. Although shown and described as being generally cylindrical conductors, it is further envisioned that the conductors may be non-cylindrically shaped, such as generally square, triangular, rectangular or flat or the like, without affecting the scope of the present invention.

By providing a high density wiring around the core of a motor, the present invention provides for a higher stall torque and, thus, a higher motor efficiency, while limiting the effects on the size and cost of the motor core. This is because the performance of a multipole direct current motor is generally controlled by several physical constraints, such as the configuration of the motor winding and, more particularly, the percentage of wire fill in the armature core slots.

Decreasing winding resistance, and thus increasing the current, increases the stall torque while the no load speed of the motor remains substantially fixed or constant. This is graphically represented in FIG. 6, where a conventional motor is represented by the curve A, while a high density winding motor in accordance with the present invention is represented by the curve B. Accordingly, for a decrease in the winding resistance of the motor (such as via an increase in the winding density), a generally proportional increase in the stall torque may result, which may result in a shift in the curve A of FIG. 6 upward and to the right, while the no load speed remains substantially constant. This increase in the stall torque of the motor may improve the motor operating efficiency, since the torque of the motor is increased for any given speed in response to the increase in stall torque of the motor, as can be seen in FIG. 6.

Because the winding resistance of a motor may be decreased by increasing the percentage of fill in the armature core slots, such an increase in the percentage of slot fill may result in a corresponding improvement in the motor operating efficiency. The present invention provides for an increase in the percentage of fill in the armature core slots by using conventional sized and shaped wirings or conductors. The improvement in operating efficiency may thus be achieved with minimal costs associated with winding the wirings onto the armature core, since minimal tooling costs are required to adapt the equipment for non-circular or non-conventional wires or the like.

Because the present invention provides a secondary wiring which is positioned or wrapped or wound between layers of a primary wiring, the overall size of the wirings or space occupied by the wirings is not substantially affected by the wiring configuration of the present invention. The winding resistance of the motor may thus be decreased while maintaining the wire pile height of the windings. Also, the secondary wiring of the present invention has minimal impact on the overall weight of the motor.

Therefore, the present invention provides a high density winding for an electrical motor by winding two different diameter, generally cylindrical wirings or conductors around the core element of the motor. The resulting high density winding provides for improved stall torque without substantially affecting other design parameters, such as wire pile height, wire termination concerns and increase in machine time and cost to manufacture the motor. Because the winding, hooking and fusing of the secondary wiring can be performed generally simultaneously with the winding, hooking and fusing of the primary wiring, the machine cycle time is not adversely affected by adding the secondary wiring of the present invention. The motor efficiency can thus be increased with minimal costs associated with the motor and minimal wire mass added to the motor. The high density winding of the present invention is thus applicable to many product lines or motor designs with minimal capital expenditure required to implement the additional wiring, since the additional wiring may be wound using conventional means and may be wound simultaneously with the existing primary wiring.

Changes and modifications in the specifically described embodiments may be carried out without departing from the principles of the invention, which is intended to be limited only by the scope of the appended claims, as interpreted according to the principles of patent law.

The embodiments of the invention in which an exclusive property or privilege is claimed are defined as follows:

1. A core for an electric motor comprising:
a core element;
a first conductor having a first diameter, said first conductor being wound around said core element a plurality of times to define a plurality of portions of said first conductor; and
a second conductor having a second diameter, said second conductor being wound around said core element a plurality of times to define a plurality of portions of said second conductor, said first diameter being greater than said second diameter, wherein at least some of said plurality of portions of said second conductor are positioned within respective voids, each of said respective voids being defined by at least three adjacent portions of said plurality of portions of said first conductor.

2. The core of claim 1, wherein said second diameter is defined by a size of said respective voids.

3. The core of claim 1, wherein said at least three adjacent portions of said plurality of portions of said first conductor comprises four adjacent portions.

4. The core of claim 3, wherein said at least some of said plurality of portions of said second conductor contact at least two of said four adjacent portions defining said respective voids.

5. The core of claim 2, wherein each portion of said four adjacent portions of said plurality of portions of said first conductor contacts two other portions of said four adjacent portions to define said respective void.

6. The core of claim 1, wherein said plurality of portions of said first conductor define first and third layers of windings.

7. The core of claim 6, wherein said plurality of portions of said second conductor define a second layer of windings, said second layer of windings being positioned generally between said first and third layers of windings.

8. The core of claim 7, wherein each of said first and third layers of windings comprise a plurality of portions of said first conductor.

9. The core of claim 8, wherein said plurality of portions of said first layer of windings contact corresponding portions of said plurality of portions of said third layer of windings.

10. The core of claim 9, wherein each portion of said plurality of portions of said first conductor contacts at least one adjacent portion of said plurality of portions of said first conductor along a respective one of said first and third layers of windings.

11. The core of claim 7, wherein said plurality of portions of said first and third layers of windings comprise a continuous strand of wire.

12. The core of claim 1, wherein said core comprises a core for a multipole direct current motor, said core element including a plurality of slots, said first and second conductors being wound around said slots of said core element.

13. The core of claim 1, wherein said plurality of portions of said second conductor is a greater number of portions than said plurality of portions of said first conductor.

14. The core of claim 1, wherein said first and second conductors comprise first and second generally cylindrical conductors.

15. A method of forming a core for an electric motor comprising:
providing a core element;
winding a first generally cylindrical conductor having a first diameter around said core element a plurality of times;
winding a second generally cylindrical conductor having a second diameter around said core element a plurality of times, said first diameter being greater than said second diameter; and
at least partially filling voids defined between at least three adjacent portions of said first generally cylindrical conductor with said second generally cylindrical conductor.

16. The method of claim 15, wherein winding said first generally cylindrical conductor defines a first and third layer of windings.

17. The method of claim 16, wherein winding said second generally cylindrical conductor defines a second layer of windings positioned between said first and third layers of windings.

18. The method of claim 17, wherein at least partially filling voids includes at least partially filling voids defined between said first and third layers of windings with said second layer of windings.

19. The method of claim 18, wherein winding said first generally cylindrical conductor includes winding said first generally cylindrical conductor to define adjacent contacting portions of said first conductor.

20. The method of claim 19, wherein a first plurality of said adjacent contacting portions of said first conductor defines said first layer of windings and a third plurality of said adjacent contacting portions of said first conductor defines said third layer of windings.

21. The method of claim 20, wherein at least some of said first plurality of adjacent contacting portions contact corresponding portions of said third plurality of adjacent contacting portions.

22. The method of claim 15, wherein winding said first conductor includes winding said first conductor around said core element a first number of times and winding said second conductor includes winding said second conductor around said core element a second number of times, said second number being greater than said first number.

23. The method of claim 15, wherein winding said first generally cylindrical conductor and winding said second generally cylindrical conductor are performed generally simultaneously.

24. The method of claim 15, wherein providing a core element includes providing a core element for a multipole direct current motor.

25. An electric motor comprising:
a core, said core including a core element, a primary generally cylindrical conductor and a secondary generally cylindrical conductor, said primary conductor having a first diameter and said secondary conductor having a second diameter, said first diameter being greater than said second diameter, said primary conductor being wound around said core element a plurality of times to define a plurality of portions of said primary conductor, said secondary conductor being wound around said core element a plurality of times to define a plurality of portions of said secondary conductor, wherein at least some of said plurality of portions of said secondary conductor are positioned within a respective void defined by at least three adjacent portions of said plurality of portions of said primary conductor.

26. The electric motor of claim 25, wherein said core comprises a core for a multipole direct current motor.

27. The electric motor of claim 26, wherein said core element includes a plurality of slots, said primary and secondary conductors being wound around said slots of said core element.

28. The electric motor of claim 25, wherein said second diameter of said secondary conductor is defined by a size of said respective voids.

29. The electric motor of claim 25, wherein said at least three adjacent portions of said plurality of portions of said primary conductor comprises four adjacent portions.

30. The electric motor of claim 29, wherein said plurality of portions of said secondary conductor contact at least two of said four adjacent portions defining said respective voids.

31. The electric motor of claim 29, wherein each portion of said four adjacent portions of said plurality of portions of said primary conductor contacts two other portions of said four adjacent portions to define a portion of said respective void.

32. The electric motor of claim 25, wherein said plurality of portions of said primary conductor define first and third layers of windings.

33. The electric motor of claim 32, wherein said plurality of portions of said first and third layers of windings comprise a continuous strand of wire.

34. The electric motor of claim 33, wherein said plurality of portions of said secondary conductor define a second layer of windings, said second layer of windings being positioned generally between said first and third layers of windings.

35. The electric motor of claim 34, wherein each of said first and third layers of windings comprise a plurality of portions of said primary conductor.

36. The electric motor of claim 35, wherein said plurality of portions of said first layer of windings contact corresponding portions of said plurality of portions of said third layer of windings.

37. The electric motor of claim 36, wherein each portion of said plurality of portions of said primary conductor contacts at least one adjacent portion of said plurality of portions of said primary conductor along a respective one of said first and third layers of windings.
